(19) United States
(12) Patent Application Publication
(10) Pub. No.: US 2009/0087825 A1
(43) Pub. Date: Apr. 2, 2009

(54) SYSTEM AND METHOD FOR FACILITATING PRAYER

(76) Inventors: ARUMUGAM GOVINDSWAMY, Irvine, CA (US); Darioush Agahi, Irvine, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/864,139

(22) Filed: Sep. 28, 2007

(51) Int. Cl. G09B 19/00

(52) U.S. Cl. 434/245

(57) ABSTRACT

The present invention provides a system and method for assisting a user to pray. The method includes calculating a direction from the present position to a reference position; displaying the direction on a user interface; calculating an away distance between a home position and the present position, wherein the home position is defined by a user; generating praying instruction based on the away distance; and presenting the generated praying instruction via the user interface.

### TECHNICAL FIELD

The present invention relates to system and method to facilitate the prayer, and more particularly, some embodiments relate to finding the direction of Mecca and notifying a user of time and specificity of praying.

### DESCRIPTION OF THE RELATED ART

Muslims are required to perform the ritual prayer called “Salat” five times a day. Salat is also known as Salah or Namaz. The five Salats to be performed each day are named as Fajr, Dhuhr, Asr, Maghrib and Isha'a. These ritual prayers are expected to be performed at certain prescribed time periods. Fajr is typically performed between dawn and sunrise. Dhuhr is performed at noon. Asr is performed in the afternoon. Maghrib is performed at sunset, and Isha'a is performed in the evening.

The Salat is to be performed in accordance with the local time zone. Accordingly, Muslims that are on travel away from home need to keep track the local time to identify the prescribed time period to perform these ritual prayers. In addition to the five mandatory Salats mentioned above, Muslims can perform other Salats on some occasions or circumstances. Important days for Muslims are based on the lunar calendar and for a given month there are other prayers that need to be performed. To assist the user Muslim Calendar is available.

Even though there are different branches of Islam (e.g., Sunni Muslims and Shi'a Muslims), all Muslims perform Salat regardless of what branch of Islam a given Muslim belongs to. However, there are certain differences in the way they perform Salat. As an example Shi'a Muslims do not put their head down directly on the ground and they will use a “Turbah”, also known as “Mohr” in Farsi, a hardened soil or clay, which acts as a medium between the forehead and the ground, where as Sunni Muslims put their head directly on to the ground. The most favored soil or clay of Turbah has to come from holy sites such as the Karbala. Despite these types of minor differences all Muslims must perform the daily prayer Salat.

Islam mandates that when Muslims perform Salat they must face towards the Kaaba located in the holy city of Mecca. The direction of facing Kaaba in Mecca while a Muslim is performing a Salat is called Qibla.

### BRIEF SUMMARY OF EMBODIMENTS OF THE INVENTION

According to various embodiments of the invention, methods and systems for assisting a user to pray are provided. In accordance with an embodiment of the invention, a method for assisting a user to pray comprises: calculating a present position with data received from an external system; calculating a direction from the present position to a reference position; displaying the direction on a user interface; calculating an away distance between a home position and the present position, wherein the home position is defined by a user; generating praying instruction based on the away distance; and presenting the generated praying instruction via the user interface. In one embodiment, the reference position is Mecca or Kaaba. Additionally, the external system is a global positioning system.

In a further embodiment, a first set of instruction is generated when the away distance is less than a threshold distance, a second set of instruction is generated when the away distance is more than a threshold distance. In one embodiment, the second set of instruction is generated based on the intent of the user on the duration of his/her stay at the away distance if the away distance is more than the threshold distance. Additionally, the threshold distance can be set by the user via the user interface.

In another embodiment, wherein the first and second sets of instruction comprise a number of Rakaahs the user needs to perform for each Salat. For e.g. in Shi'a branch of Islam Salats that require 4 Rakaahs is reduced to 2 Rakaahs while the rest stays the same. However in Sunni branch of Islam the number of Rakaahs does not change but the Musafir is allowed to perform Dhuhr and Asr one after another at the same time and likewise the Musafir can perform Maghrib and Isha one after another at the same time.

In a further embodiment, the method includes a function for tracking the number of Rakaahs being performed by the user with feedback data from a sensor. In one embodiment, the sensor is an internal motion sensor configured to detect a Rakaah movement based on a signal profile. Alternatively, the sensor comprises an external sensor configured to sense the user going from a standing position to a prostrating position.

In yet another embodiment of the present invention, a method for assisting a user to pray is provided. The method involves calculating a present position with data received from a global positioning system; calculating a direction from the present position to a reference position; determining a prayer time based on the present position; notifying a user when the prayer time comes; displaying the direction on a user interface; and tracking a praying motion being performed by a user using feedback data from a sensor.

In yet another embodiment of the present invention, an apparatus is for assisting a user to pray is provided. The apparatus includes a first module configured to receive data from an external source and to determine a present position; a second module configured to determine a direction from the present position to a reference position; a user interface configured to display the direction; a third module configured to determine an away distance between a home position and the present position, wherein the home position is defined by a user; and a fourth module configured to generate praying instruction based on the away distance and to present the generated praying instruction via the user interface.

In one embodiment, the apparatus further includes a fifth module configured to track the number of Raka'ahs being performed by the user using feedback data from a sensor. The sensor may be an internal motion sensor configured to detect a Raka'ah movement based on a signal profile. Alternatively, the sensor comprises an external sensor configured to sense the user going from a standing position to a prostrating position.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following Figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates an example environment in which a prayer facilitating device can be implemented in accordance with an embodiment of the present invention.

FIG. 2 illustrates an example prayer facilitating device according to an embodiment of the present invention.

FIG. 3 illustrates an example circuit block diagram of the prayer facilitating device shown in FIG. 2 according to an embodiment of the present invention.

FIGS. 4-6 illustrate example block diagrams of process flows that can be implemented by the prayer facilitating device according to embodiments of the present invention.

It should be understood that the invention can be practiced with modification and alteration, and that the invention be limited only by the claims and the equivalents thereof.

### DETAILED DESCRIPTION OF THE EMBODIMENTS OF THE INVENTION

1. Overview

As mentioned, Muslims are required to perform the ritual prayer called “Salat” five times a day. The five Salats are Fajr, Dhuhr, Asr, Maghrib and Isha'a. Each Salat is performed in units called Raka'ah, which consists of mandatory and voluntary Raka'ah. Generally, a Raka'ah consists of a series prayer movements and sometime is accompanied by recitation of supplications and verses in the Qur'an. A Raka'ah—a unit or group of various praying motions—begins with a Qiyaam position and ends with a Sujood position. Qiyaam is the standing position, and Sujood is a prostrate position.

Mass prayer (i.e. praying in a mosque) is usually coordinated by a prayer coordinator. This person typically cues the time to start each movement in a Raka'ah and recites supplications and verses in the Qur'an.

Musafir status may be achieved when the Muslim has traveled a specified distance away from home and for a prescribed duration. In Shi'a branch of Islam, the requirement for performing the number of Raka'ah for Dhuhr, Asr, Isha'a is reduced from four to two when the Shia'a Muslim has attained Musafir status. In Sunni branch of Islam, Dhuhr and Asr Salats can be performed one after another at the same time and Maghrib and Isha'a can be performed one after another at the same time.

In one embodiment, a prayer facilitating device is configured to act as a personal prayer coordinator by performing one or more of the following functions: keep track of the local time; keep track of praying times for Fajr, Dhuhr, Asr, Maghrib and Isha'a; determine whether the user has Musafir status; notify the user of praying time; generate praying instructions based on Musafir status; keep track of the number of Raka'ahs performed; recite a supplication or a verse of the Qur'an based on the number of completed Raka'ah.

To help keep track of the time and various methods of praying, the prayer facilitating device can be configured to recognize the praying rituals of various branches of Islam such as, for example, Sunni, Shi'a, and Sufi. In this way, the prayer facilitating device may give proper praying instructions based on the setting of the user's preference of the Islamic branch. In addition, by incorporating positioning determination functionalities such as, for example, GPS, the prayer facilitating device can be configured to track the user's distance and time away from home in order to determine the user's Musafir status. In one embodiment, once Musafir status is achieved, the prayer facilitating device may update the praying instructions based on any changes in the praying ritual and notify the user of the changes. Preferably, this is done automatically without the user's intervention after the device has been properly initialized for a certain branch of Islam.

In one embodiment, the prayer facilitating device is configured to detect a full Raka'ah movement using a motion sensor. A full Raka'ah movement is a movement that starts with the Qiyaam position and ends with a Sujood position. In one embodiment, the motion sensor is internal to the prayer facilitating device. Alternatively, the motion sensor is an external sensor configured to detect the full Raka'ah motion or only the Sujood position.

Typically, the Raka'ah is performed while contemporaneously reciting the “Takbir” (God is great), supplications, and verses of the Qur'an. Thus, by keeping track how many Raka'ah the user has performed, the prayer facilitating device may properly playback the Takbir, supplications, or verses in the Qur'an at a proper time. For example, a Raka'ah may start with the recitation of the Takbir, supplication, and the Surah al-Fatiha of the Qur'an before the first bow or “ruk'u”. Thus, the user may use the prayer facilitating device as a cue and bow after the device finishes reciting the al-Fatiha. Alternatively, the prayer facilitating device may restart the recitation of the Takbir, supplication, and the al-Fatiha after it has detected a Sujood is completed and the user is back in the Qiyaam position.

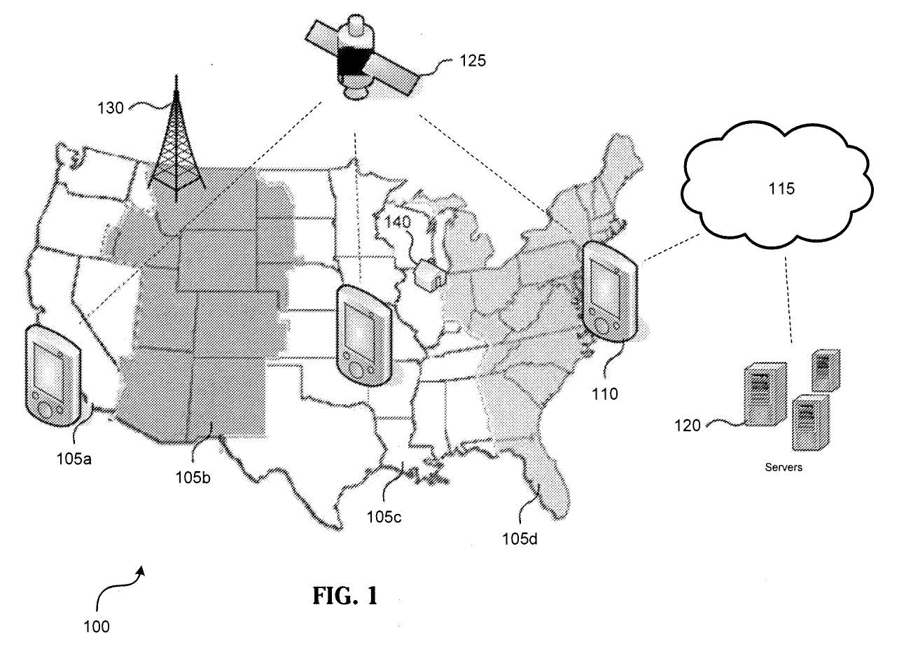

Before describing the prayer facilitating device in further detail, it is useful to describe an example environment with which the invention can be implemented. FIG. 1 is a diagram illustrating one example of an operating environment 100 in accordance with one embodiment of the invention. Referring now to FIG. 1, environment 100 includes a plurality of time zones 105a-d, a prayer facilitating device 110, a network 115, a server 120, a satellite 125, and ground communication network 130. Prayer facilitating device 110 is preferably a portable device and can be a stand-alone device or integrated with another device such as, for example, a mobile telephone, a personal digital assistance (PDA), a navigation device, a wrist watch, and a laptop computer or portable computing device. In one embodiment, prayer facilitating device can be implemented as a standalone software application or a combination of software and hardware modules that can be installed a host device such as, for example, the devices mentioned above. Prayer facilitating device 110 can be configured to communicate with network 115 using wireless communication standards such as, for example, Wi-Fi, WiMAX (Worldwide Interoperability for Microwave Access), or other suitable wireless communication standards. Prayer facilitating device 110 can also be configured to communicate with network 115 using wired communication standards such as, for example DSL (Digital Subscriber Line), Cable Modem or other suitable wired communication standards. Prayer facilitating device 110 may communicate with server 120 via network 115.

In one embodiment, prayer facilitating device 110 is configured to communicate with one or more global positional system (GPS) satellites 125. This allows device 110 to determine its current position and time zone. Prayer facilitating device 110 can also be configured to communicate with a ground based antenna 130 using a mobile communication standard such as, for example, CDMA (code division multiple access), GSM (Global System for Mobile communications), or EVDO (Evolution-Data Optimized).

Prayer facilitating device 110 may use various communication means described above to gather information from server 120. Information gathered by prayer facilitating device 110 may include information such as, for example, praying instructions, time of sunrise and sunset for a particular time zone. This information may be used to calculate the five proper times for the five Salats. Alternatively, prayer facilitating device 110 may obtain the exact time for each of the five Salats from server 120 based on device's 110 present location. In one embodiment, prayer facilitating device 110 includes a database that contains the praying time for the five Salats in preferably all of the time zones in the world. In this way, prayer facilitating device 110 may determine the praying times locally once it has determined its current time zone.

As illustrated in FIG. 1, prayer facilitating device 110 may be located in various regions of the country with different time zones. In one embodiment, a home position 140 may be selected for prayer facilitating device 110. The home position can be anywhere and can be set by the user. Using home position 140, prayer facilitating device 110 may calculate an away distance, which is the distance between the present position and home position 140. The away distance may be used to determine whether the user has attained Musafir status. Additionally, prayer facilitating device 110 is also configured to keep track of an away time, which is a time duration where the away distance is greater than a specified threshold distance. For example, the threshold distance may be 48 miles or 77 kilometers. In one embodiment, the Musafir status is attained if the intent of the user to stay at the away distance less than the prescribed time, which can be 15 days, for example. As mentioned, once Musafir status is detected, prayer facilitating device 110 may update the praying instructions based on any changes in the praying ritual and notify the user of the changes. Preferably, this process is automatically performed.

2. Prayer Facilitating Device

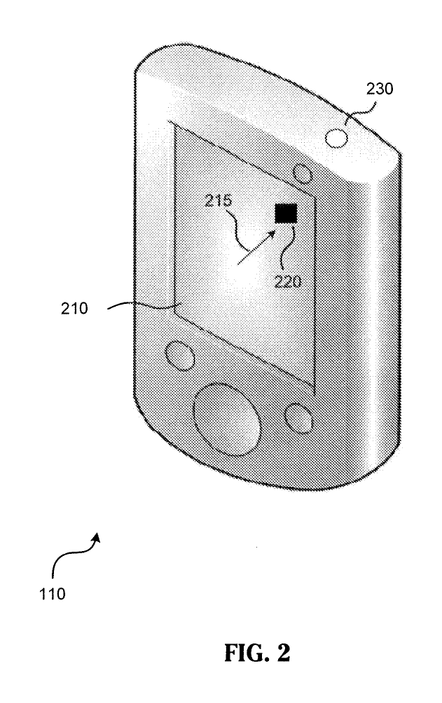

FIG. 2 is an example of prayer facilitating device 110 in accordance with one embodiment of the invention. Referring now to FIG. 2, prayer facilitating device 110 includes a user interface 210, a Qibla directional arrow 215, a Mecca symbol 220, and an output port 230. In operation, according to one embodiment, Qibla directional arrow 215 starts at a current position, determined using signals from positioning determination system 125, and points toward Kaaba—a holy structure located in the city of Mecca, Saudi Arabia—which is represented by Mecca symbol 220 on user interface 210. In one embodiment, positioning determination system 125 comprises a global positioning system or a ground communication network such as, for example, a cellular network, or other communication network. As an example, the position of a subscriber in a cellular network can be determined by using a triangulation method, for example. In one embodiment, prayer facilitating device 110 notifies the user of the time to pray via user interface 210 or via an internal speaker (not shown). Additionally, prayer facilitating device 110 is configured to present praying instructions to the user using user interface 210, the internal speaker, and audio output port 230. Also the prayer facilitating device will display the number of Raka'ahs completed. Also the Display can shown the North-South-East-West directions and along with the direction of Qibla.

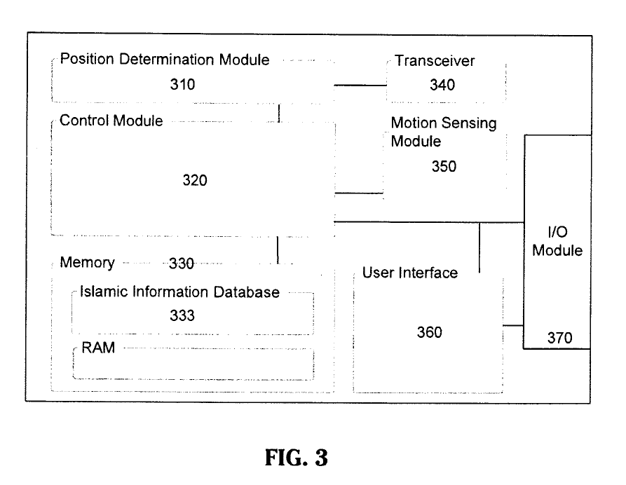

FIG. 3 is a circuit block diagram of prayer facilitating device 110 according to one embodiment of the present invention. Referring now to FIG. 3, prayer facilitating device 110 includes a position determination module 310, a control module 320, a memory 330, an Islamic info database 333, a transceiver 340, a motion sensing module 350, a user interface 360, and an I/O module 370. In the illustrated embodiment, position determination module 310 and transceiver 340 are used to communicate with positioning determining system 125 to determine the current position and time zone of prayer facilitating device 110.

Control module 320 is configured to use the current position and time zone data to determine the time for Salats by querying Islamic info database 333 that may be part of memory 330. In one embodiment, Islamic info database 333 can be configured to store the praying time for the five Salats for preferably all time zones in the world. Alternatively, control module 320 may communicate with server 120 to query for the praying time for the five Salats based on the current position and time data from position determination module 310. In one embodiment, position determination module 310 is configured to determine the present position using signals from one or more satellites of a global positioning system. Alternatively, position determination module 310 is configured to determine the present position using signals from one or more antenna towers of a cellular network. Position determination module 310 can also be configured to include an electronic compass for determining headings, or a direction in which the device is pointed. Accordingly, a digital compass ‘heading’ along with a current GPS position can be used to determine the direction for Qibla directional arrow 215.

Memory 330 may comprise a magnetic disk drive, a flash memory, a RAM, a DRAM, a MRAM, or other suitable memory medium. In one embodiment, Islamic info database 333 contains praying related data such as, for example, audio clips of Takbir, supplications, and verses of the Qur'an. In this way, in one embodiment, prayer facilitating device 110 can recite one or more of the Takbir, supplications, and verses of the Qur'an such as the al-Fatiha via a speaker (now shown) or I/O module 370.

In addition to determining what time Salats have to be performed, control module 320 can also be configured to determine the Musafir status of the user. In one embodiment, control module 320 can be configured to obtain time and present position data from position determination module 310. These data are then used to determine an away distance, the distance between the present position and a home position. Additionally, an away time is also calculated, which is the time duration when the away distance is greater than a threshold distance. In one embodiment, the threshold distance and the home position can be set by the user. Depending upon the user configuration, Musafir status can be attained with a certain away distance and away time. For example, a user may set the away distance and away time to be 77 kilometers and less than 15 days, respectively. In this example, the user attains Musafir status once the user is more than 77 kilometers away from the home position and the intention to stay in the away distance less than the prescribed time which is 15 days, for example.

Once the Musafir status has been achieved, prayer facilitating device 110 may update praying instructions according to guidelines observed by the user. In one embodiment, Islamic info database 333 may store praying instructions for some or all of the major branches of Islam. Praying instructions may include instructions for praying while at home and instructions for praying while having Musafir status. Thus, in one embodiment, control module 320 can be configured to query Islamic info database 333 to obtain the proper praying instructions based on the branch of Islam, the local time zone, and the traveling status of the user. For example, while at home, a certain branch of Islam may require the user to perform the following routine: 2 Raka'ahs for the Fajr Salat, 4 Raka'ahs for the Dhuhr Salat, 4 Raka'ahs for the Ashr Salat, and 3 Raka'ahs for the Maghrib Salat and 4 Raha'ahs for Isha'a. However, if the Shi'a user has Musafir status, the praying requirement may be reduced to 2 Raka'ahs for Dhuhr, Asr and Isha's Salats, for example. Alternatively, the prayer facilitating device 110 may instruct the Sunni user to perform the Salats for Dhuhr and Asr and Maghrib and Isha'a one after another at the same time.

Prayer facilitating device 110 can also be configured to detect the movements of a Raka'ah or when the user has just completed or in the Sujood position. In one embodiment, this is done using motion sensor module 350. In one embodiment, the ability to detect the movement of a Raka'ah or when the user is in the Sujood position enables prayer facilitating device 110 to act as a prayer coordinator. For example, at the start of a Raka'ah, prayer facilitating device 110 may playback audio clips of the Takbir and al-Fatiha, thus cueing the user to bow after the device finishes reciting the al-Fatiha. Alternatively, the prayer facilitating device may restart the recitation of the Takbir, supplication, and the al-Fatiha after it has detected that a Sujood is completed and the user is back in the Qiyaam position, thereby starting a second Raka'ah.

In one embodiment, to detect a complete Raka'ah movement—movements from the Qiyaam position to the Sujood position—motion sensor 350 can be configured to compare a reference signals profile, a previously recorded signals profile of a complete Raka'ah movement, with a signals profile currently being sensed. In one embodiment, if the two signal profiles match with a certain percentage of confidence, then it can be assumed that a Raka'ah has been performed. To achieve good detection results, the user is encouraged to place prayer facilitating device 110 in the same general location of the user's body every time the user performs a Raka'ah.

In one embodiment, the user may set motion sensor 350 in a learning mode via user interface 360. Once motion sensor 350 is set to learning mode, the user may perform a model Raka'ah movement and the signals profile generated during the model Raka'ah movement can be stored. In this way, motion sensor 350 may use the learned signals profile and compare it with live motion signals being detected during operation. To achieve good detection results, it is preferable to place prayer facilitating device 110 in the same area of the body while in learning mode and in normal operation mode. For example, where previously recorded signals profile was generated using a motion sensor attached to a part of the body of the user of prayer facilitating device, to achieve good detection results, the user should place prayer facilitating device 110 in the same part of the body when performing a Raka'ah. It should be noted that other appropriate locations of the body may also be used. For certain branches of Islam, it is inappropriate to wear jewelry, and watches, etc, while performing the Raka'ah. Accordingly, an external sensor (not attached to the body) can be provided to detect the Raka'ah movement.

In one embodiment, a complete Raka'ah may be detected by detecting when the user is in a Sujood position. In one embodiment, an external sensor can be placed on the ground where the prayer's knee or shin touches it while performing the Salat. Thus, when the prayer is in the Sujood position, the sensor will be activated thereby allowing the Raka'ah movement to be detected and indicated in the display. In this embodiment, the external sensor may be configured to communicate with sensor module 350 wirelessly using Bluetooth, infrared, or other suitable wireless communication means. Alternatively, the external sensor can be coupled to prayer facilitating device 110 using a wired connection. In one embodiment, praying assisting device 110 can be configured to use data from both the internal and external motion sensors to determine whether a Raka'ah as been performed.

3. Prayer Facilitating Device Process Flow

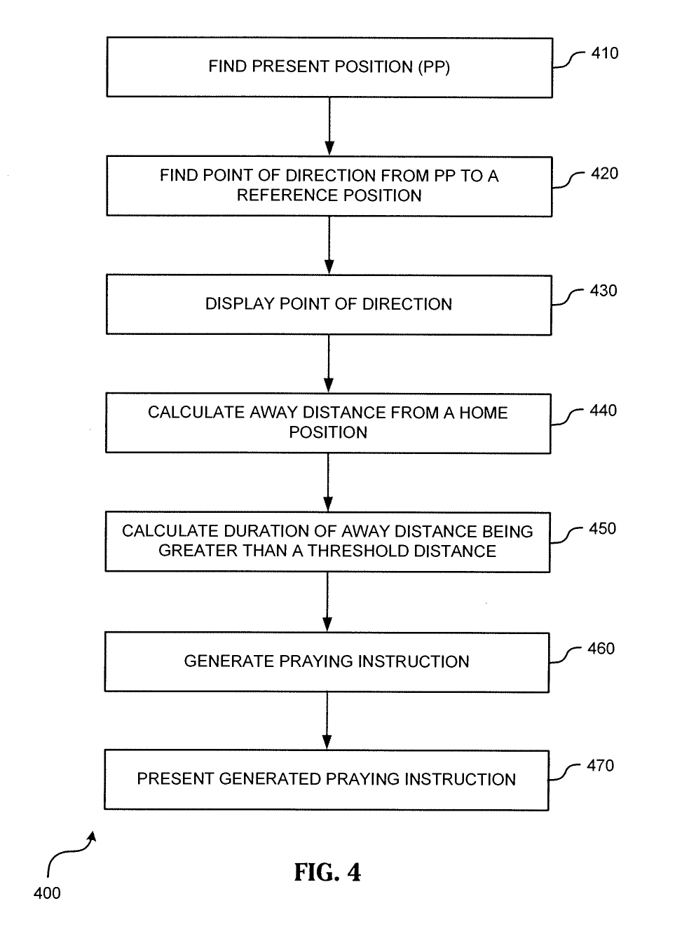

FIG. 4 is a diagram illustrating a high-level flow for assisting a user in a praying custom according to one embodiment of the present invention. Referring now to FIG. 4, in a step 410, a present position of the user is determined. This is preferably done using positioning determining system 125 and position determination module 310.

In a step 420, the point of direction from the present position to a reference position is generated. In one embodiment, the reference position is Mecca. As mentioned, the direction that points toward Mecca from the user's present position is also referred to as Qibla. In a step 430, a representation of Qibla is displayed to the user. For example, Qibla directional arrow 215 as shown in FIG. 2.

In a step 440, the away distance is calculated. The away distance is the distance from the present position to a home position, which can be specified by the user. Since prayer facilitating device 110 can be equipped with position determination module 310, the away distance can be readily determined. In one embodiment, position determination module 310 is configured to determine the present position using signals from one or more satellites of a global positioning system. Alternatively, position determination module 310 is configured to determine the present position using signals from one or more antenna towers of a cellular network. Other automated position determination techniques could also be used as could manual entry. For example, the user could be prompted to enter latitude and longitude coordinates, a street address or other means for identifying the current location. Also, maps could be displayed with the ability to zoom into the map so that the user can manually enter a position via the map display.

In a step 450, the away time is calculated, which is the time duration of the away distance being larger than a specified distance. For example, the specified or threshold distance may be set at 77 kilometers. Thus, in this scenario, the away time starts to accumulate when the user is more than 77 kilometers away from the home position. In one embodiment, praying assisting device 110 is set to Musafir status once the away distance is set and the intention to stay in the away distance less than prescribed duration which is 15 days for example.

In a step 460, the praying instruction is generated. In one embodiment, praying instructions can be generated based on one or more of the following variables: the present position, the user's affiliation to the branch of Islam, the user's Musafir status, and the local time. In a step 470, the generated praying instruction is presented to the user. In one embodiment, the generated praying instruction is presented via user interface 210 or by audio via a speaker or I/O output 370.

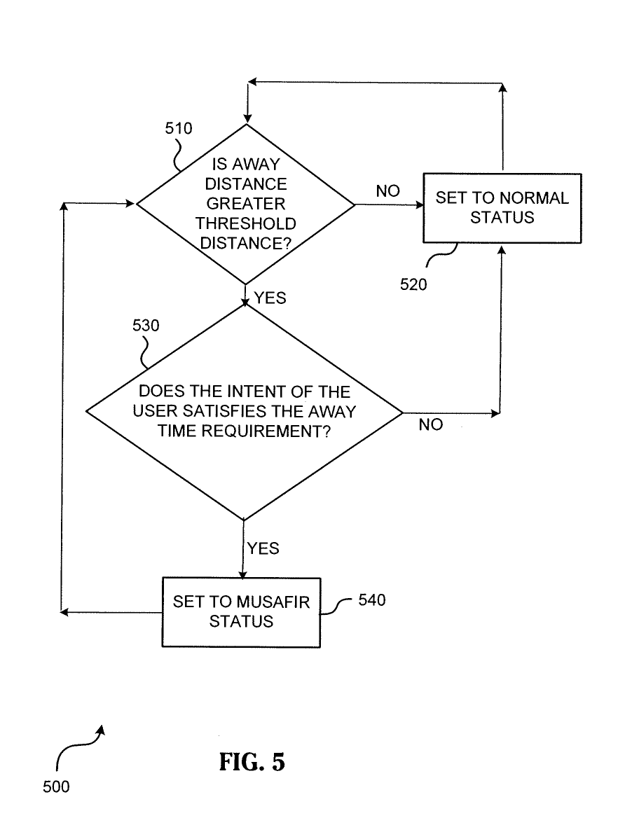

FIG. 5 is a diagram illustrating a process flow 500 for determining whether the user has attained Musafir status in accordance with one embodiment of the invention. Referring now to FIG. 5, flow 500 starts at a step 510 in which it is determined whether the away distance is greater than the specified threshold distance. If the answer is ‘no’ in step 510, then prayer facilitating device 110 is set to normal status in a step 520. If the answer is ‘yes’ in step 510, the process proceeds to a step 530.

In step 530, it is determined whether the intention of the user to stay away at the distance less than the prescribed time. If the answer is ‘no’ in step 520, then prayer facilitating device 110 remains at normal status or set to normal status in step 520 if it is not currently in normal status. If the answer is ‘yes’ in step 520, prayer facilitating device 110 is set to Musafir status in step 540. In one embodiment, prayer facilitating device 110 preferably loops through steps 510-540 constantly or whenever it is on the move. In this way, the user can be kept updated as to his Musafir status.

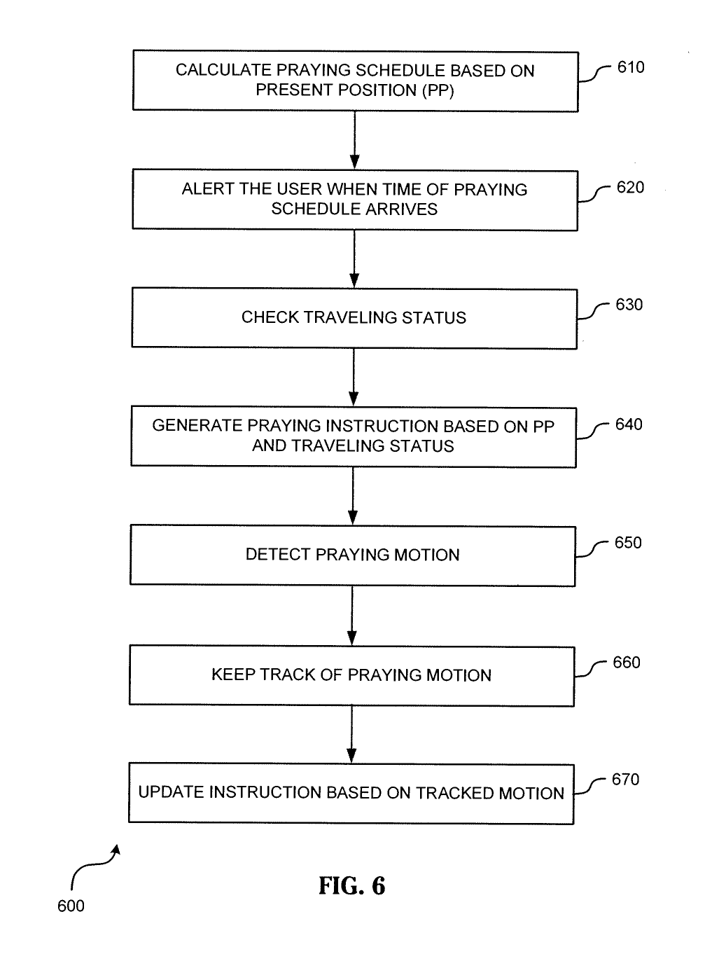

FIG. 6 is a diagram illustrating an operation flow 600 in accordance with one embodiment of the invention. Referring now to FIG. 6, flow 600 starts at a step 610 in which the praying schedule is determined based on the present location of the user. In one embodiment, the praying schedule may be determined by querying a local database, such as Islamic database 333, having the praying schedules of preferably all or most of the time zones in the world. Alternatively, the praying schedules may be obtained by querying a remote server such as, for example, server 120.

In a step 620, the user is alerted when the scheduled time for prayer arrives. In one embodiment, the user is presented with the day schedule or the entire praying schedule for the week for example. The user can be alerted of the scheduled praying time using various modes such as using light, sounds, vibrations, or other audible, tactile, visual or other sensory feedback.

In a step 630, the traveling or Musafir status of the user is determined. In a step 640, praying instructions are generated based on the user's present position and Musafir status of the user. For example, the user may be instructed to perform two Raka'ah for the Fajr Salat at 5:24 am and four Raka'ah for the Dhuhr Salat at 12:00 pm. Alternatively, the praying instruction may be amended based on the user's Musafir status and the user's religious guidelines. For example, while having the Musafir status, the user may be instructed to perform the Fajr and Dhuhr Salats one after another at the same time for example.

In a step 650, the motions for the Raka'ah are detected. In one embodiment, the user may notify praying assisting device 110 that he will start the Raka'ah movement. In this way, praying assisting device 110 can begin collecting and analyzing motion data. As mentioned, praying assisting device 110 may detect a Raka'ah motion using motion sensor 350 or an external motion sensor. In one embodiment, functionalities of motion sensor 350 and the external motion sensor can be combined to enhance the motion detectability of praying assisting device 110.

In a step 660, the Raka'ah motion is recorded and tracked during a Salat. In this way, praying assisting device 110 can be configured to playback the Takbir, supplications, or verses in the Qur'an at a certain time, such as at the start of the Qiyaam position or the end of the Sujood position or a time thereafter.

In a step 670, the praying instruction may be updated during the Salat process. For example, certain Islamic guidelines may dictate that after a bow the Muslin is to recite the al-Fatiha for the first Raka'ah but not the last Raka'ah of the Salat. Thus, by knowing how many Raka'ah has been performed from step 660, prayer facilitating device 110 may inform, for example, which passage to recite or not to recite and when the Salat is completed.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for assisting a user to pray comprising:
calculating a present position with data received from an external system;
calculating a direction from the present position to a reference position;
displaying the direction on a user interface;
calculating an away distance between a home position and the present position, wherein the home position is defined by a user;
generating praying instruction based on the away distance; and
presenting the generated praying instruction via the user interface.

2. The method of claim 1, further comprising displaying a number of Raka'ahs completed.

3. The method of claim 1, wherein the reference position is Mecca.

4. The method of claim 1, wherein generating praying instruction further comprises:
generating a first set of instruction when the away distance is less than a threshold distance; and
generating a second set of instruction when the away distance is more than a threshold distance.

5. The method of claim 4, wherein the second set of instruction is generated based on an intent of the user of a duration of stay at the away distance.

6. The method of claim 3, wherein the threshold distance is set by the user via the user interface.

7. The method of claim 1, wherein the external system is a global positioning system.

8. The method of claim 3, wherein the first and second sets of instruction comprise a number of Raka'ahs the user needs to perform for each Salat.

9. The method of claim 7, wherein the number of Rakaahs in the second set is less than the number of Rakaahs in the first set.

10. The method of claim 1, further comprising:
tracking a number of Raka'ahs being performed by the user with feedback data from a sensor.

11. The method of claim 9, wherein the sensor is an internal motion sensor configured to detect a Raka'ah movement based on a signal profile.

12. The method of claim 9, wherein the sensor comprises an external sensor configured to sense the user going from a standing position to a prostrating position.

13. A method for assisting a user to pray comprising:
calculating a present position with data received from a position determination system;
calculating a direction from the present position to a reference position;
determining a prayer time based on the present position;
notifying a user when the prayer time arrives;
displaying the direction on a user interface; and
tracking a praying motion being performed by a user using feedback data from a sensor.

14. The method of claim 12, wherein the sensor is an internal motion sensor configured to detect a praying motion based on a signal profile of the sensor.

15. The method of claim 13, wherein the sensor comprises an external sensor configured to sense the user going from a standing position to a prostrating position.

16. An apparatus for assisting a user to pray comprising:
a first module configured to receive data from an external source and to determine a present position;
a second module configured to determine a direction from the present position to a reference position;
a user interface configured to display the direction;
a third module configured to determine an away distance between a home position and the present position, wherein the home position is defined by a user; and
a fourth module configured to generate praying instruction based on the away distance and to present the generated praying instruction via the user interface.

17. The apparatus of claim 16, wherein the reference position is Mecca.

18. The apparatus of claim 16, wherein the fourth module is configured to generate a first set of instruction when the away distance is less than a threshold distance and to generate a second set of instruction when the away distance is more than a threshold distance.

19. The apparatus of claim 18, wherein the second set of instruction is generated based on an amount of time the away distance is more than the threshold distance.

20. The apparatus of claim 18, wherein the threshold distance is set by the user via the user interface.

21. The apparatus of claim 16, wherein the external system is a global positioning system.

22. The apparatus of claim 17, wherein the first and second sets of instruction comprise instructions are different.

23. The apparatus of claim 15, further comprising:
a fifth module configured to track a Raka'ah being performed by the user using feedback data from a sensor.

24. The apparatus of claim 23, wherein the sensor is an internal motion sensor configured to detect a Raka'ah movement based on a signal profile.

25. The apparatus of claim 23, wherein the sensor comprises an external sensor configured to sense the user going from a standing position to a prostrating position.

26. The method of claim 1, further comprising displaying the away distance on a user interface.
